(19) United States
(12) Patent Application Publication
(10) Pub. No.: US 2003/0108332 A1
(43) Pub. Date: Jun. 12, 2003

(54) System and method for detecting the nature of a video signal

(75) Inventors: Diego Coste, Varce (FR); Herve Maffini, F-Saint Martin d'Heres (FR)

Correspondence Address: FLEIT, KAIN, GIBBONS,, GUTMAN & BONGINI, P.L., ONE BOCA COMMERCE CENTER, 551 NORTHWEST 77TH STREET, SUITE 111, BOCA RATON, FL, 33487, US

(73) Assignee: STMICROELECTRONICS S.A., Montrouge (FR)

(21) Appl. No.: 10/291,207

(22) Filed: Nov. 8, 2002

(30) Foreign Application Priority Data
Nov. 9, 2001 (FR) 01 14532

(51) Int. Cl. H04N 5/95; H04N 5/08

(52) U.S. Cl. 386/85; 348/525

(57) ABSTRACT

A system and method for detecting the nature of a video signal using a video synchronization circuit including a phase locked loop having a time constant is disclosed. The method includes calculating a horizontal phase difference between a predetermined first line of the video signal and a predetermined second line of the video signal, the predetermined first line and the predetermined second line bracketing a change of frame. If the horizontal phase difference is greater than a threshold, the video signal is deemed to be a video recorder signal. The method further includes adjusting the time constant of the phase locked loop of the video synchronization circuit according to the nature of the video signal, as determined in the calculating step.

### CROSS-REFERENCE TO RELATED APPLICATIONS

This application is based upon and claims priority from French Patent Application No. 01 14532, filed Nov. 9, 2001, the entire disclosure of which is herein incorporated by reference.

### BACKGROUND OF THE INVENTION

1. Field of the Invention

The present invention relates to the field of video signal processing, and more specifically to detecting the nature of a video signal.

2. Description of Related Art

Consumer video recorders often supply video signals that do not conform to broadcast standards. The discrepancies in non-conforming video signals relate to the non-continuity of a horizontal phase, high fluctuations of the line period, and nonconformance to the number of lines per frame. Video signals of this type produce poor quality images when they are sent to receivers designed for standardized signals, such as broadcast signals. Receivers are typically in a synchronization mode favoring the elimination of jitter, in which the phase-locked loop has a long time constant. However, in this type of synchronization mode the receivers are incapable of tracking variations in the input signal. This can result in an image distorted by the flag effect (in which vertical lines appear wavy) or a loss of horizontal or vertical synchronization, where the picture disappears from the screen.

Therefore, it is beneficial to be able to detect the nature of the video source, particularly the presence of a video recorder. Currently, there are various methods for detecting video recorders available. Most of these methods were developed using analog circuits. Analog synchronization circuits, however, are unable to express the phase error associated with a particular line, because the phase error is integrated in a capacitor and remains unknown. The phase error contains a great deal of information regarding the video signal. The change in the video recorder read head at the end of a frame, or during the frame in special modes (fast forward scanning, for example), is virtually always associated with a source phase discontinuity, which is reflected in the phase error. Apart from the analog methods for detecting video recorders, existing digital methods merely consist of detecting the presence of the phase jumps corresponding to the change in the video recorder read head at the end of a frame. Thus, it is important to minimize the risk of errors in such phase jump detection. For example, an error due to noise must not be mistaken for a phase jump. Further, signals encrypted to prevent copying have an end of frame distortion that can be incorrectly interpreted as a phase jump.

Therefore, a need exists to overcome the problems with the prior art as discussed above, and particularly for a way to efficiently detect the nature of a video source, particularly the presence of a video recorder.

### SUMMARY OF THE INVENTION

In view of these drawbacks, the present invention overcomes the above-mentioned drawbacks and provides and method and apparatus for efficiently detect the nature of a video source, particularly the presence of a video recorder.

One embodiment of the present invention provides a method for detecting the nature of a video signal using a video synchronization circuit including a phase locked loop having a time constant. The method includes calculating a horizontal phase difference between a predetermined first line of the video signal and a predetermined second line of the video signal, the predetermined first line and the predetermined second line bracketing a change of frame. If the horizontal phase difference is greater than a threshold, the video signal is deemed to be a video recorder signal. The method further includes adjusting the time constant of the phase locked loop of the video synchronization circuit according to the nature of the video signal, as determined in the calculating step.

Another embodiment of the present invention provides a system for detecting the nature of a video signal using a video synchronization circuit including a phase locked loop having a time constant. The system includes a means for calculating a horizontal phase difference between a predetermined first line of the video signal and a predetermined second line of the video signal, the predetermined first line and the predetermined second line bracketing a change of frame. If the horizontal phase difference is greater than a threshold, the video signal is deemed to be a video recorder signal. The system further includes a means for adjusting the time constant of the phase locked loop of the video synchronization circuit according to the nature of the video signal, as determined by the means for calculating.

Yet another embodiment of the present invention provides an integrated circuit for detecting the nature of a video signal using a video synchronization circuit including a phase locked loop having a time constant. The integrated circuit includes a first module for calculating a horizontal phase difference between a predetermined first line of the video signal and a predetermined second line of the video signal, wherein the predetermined first line and the predetermined second line bracket a change of frame and wherein if the horizontal phase difference is greater than a threshold, the video signal is deemed to be a video recorder signal. The integrated circuit further includes a second module for adjusting the time constant of the phase locked loop of the video synchronization circuit according to the nature of the video signal, as determined by the first module.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention will be apparent from the following detailed description taken in conjunction with the accompanying drawings.

FIG. 1 is a diagram of a video synchronization circuit, according to one embodiment of the present invention.

FIG. 2 is a chart depicting the operation of the phase difference calculation process, according to another embodiment of the present invention.

FIG. 3 is a flowchart depicting the operation and control flow of the video mode determination process, according to yet another embodiment of the present invention.

FIG. 4 is a flowchart depicting the operation and control flow of the video mode determination process, according to yet another embodiment of the present invention.

### DETAILED DESCRIPTION OF PREFERRED EMBODIMENTS

Preferred embodiments of the present invention will be described in detail hereinbelow with reference to the attached drawings.

Preferred embodiments of the present invention provide a method for detecting the nature of a video signal using a video synchronization circuit including a phase locked loop having a time constant. The method includes calculating a horizontal phase difference between a predetermined first line of the video signal and a predetermined second line of the video signal, the predetermined first line and the predetermined second line bracketing a change of frame. If the horizontal phase difference is greater than a threshold, the video signal is deemed to be a video recorder signal. The method further includes adjusting the time constant of the phase locked loop of the video synchronization circuit according to the nature of the video signal, as determined in the calculating step.

Another embodiment of the present invention provides a system for detecting the nature of a video signal using a video synchronization circuit including a phase locked loop having a time constant. The system includes a means for calculating a horizontal phase difference between a predetermined first line of the video signal and a predetermined second line of the video signal, the predetermined first line and the predetermined second line bracketing a change of frame. If the horizontal phase difference is greater than a threshold, the video signal is deemed to be a video recorder signal. The system further includes a means for adjusting the time constant of the phase locked loop of the video synchronization circuit according to the nature of the video signal, as determined by the means for calculating.

Yet another embodiment of the present invention provides an integrated circuit for detecting the nature of a video signal using a video synchronization circuit including a phase locked loop having a time constant. The integrated circuit includes a first module for calculating a horizontal phase difference between a predetermined first line of the video signal and a predetermined second line of the video signal, wherein the predetermined first line and the predetermined second line bracket a change of frame and wherein if the horizontal phase difference is greater than a threshold, the video signal is deemed to be a video recorder signal. The integrated circuit further includes a second module for adjusting the time constant of the phase locked loop of the video synchronization circuit according to the nature of the video signal, as determined by the first module.

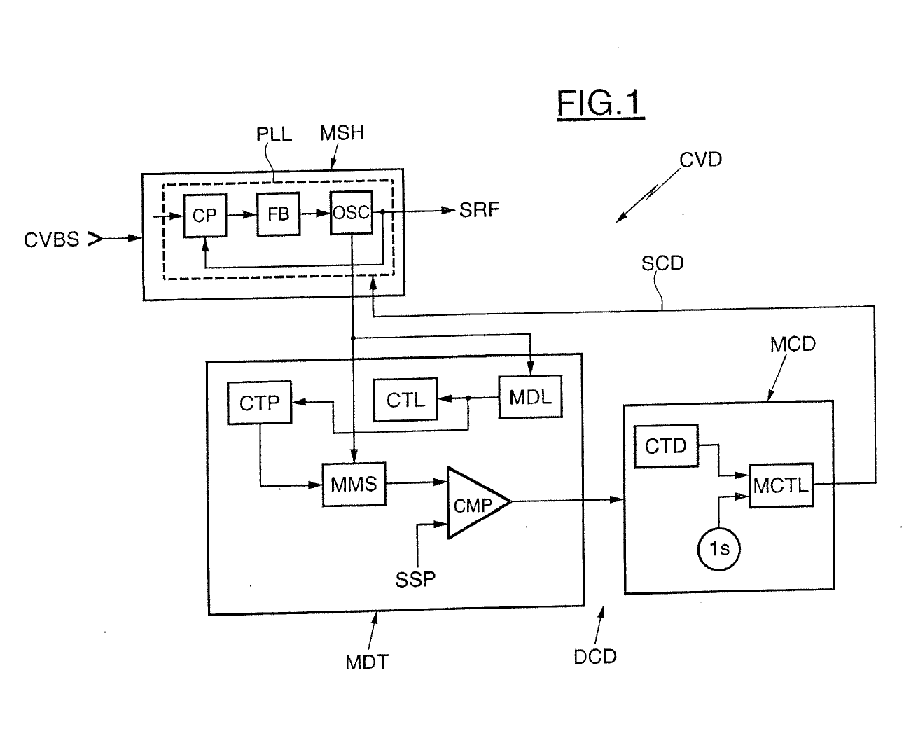

Exemplary embodiments of the present invention will now be described in detail with reference to FIGS. 1-4.

The present invention overcomes the above-mentioned drawbacks and to detect the nature of a video signal with a video synchronization circuit, particularly to detect the presence of a video recorder. In another embodiment, the present invention prevents the mistaken identification of distorted video signals, encrypted for copy protection, as phase jumps characteristic of a video recorder. Video signals encrypted to prevent copying give rise to errors because of the distortion of the video signal. These encrypted video signals, however, do not lead to any actual phase discontinuity. In the case of video signals from video cassettes, these errors correspond to a actual phase discontinuity.

In one embodiment of the present invention, the line phases of two consecutive frames are compared to verify the presence of a phase jump. The two lines compared are chosen to bracket the area of disturbance. Therefore, line 245, for example, is the predetermined first line, with a delay of 128 lines, for example, before verifying the phase. Depending on the type of program, the delay of 128 lines terminates either at line 110 (60 Hz scanning) or at line 60 (50 Hz scanning). Line 245 is a good reference line because it normally cannot be modified for encryption for copy protection. Lines 60 and 110 are also appropriate because they are sufficiently far away from the frame flyback for the phase-locked loop of the video synchronization circuit to recover good phase alignment, regardless of disturbances that may arise in the vicinity of vertical synchronization.

In another embodiment of the present invention, the phase-locked loop is a digital loop including an oscillator formed of a cyclic line recurrence counter incremented by the clock signal and which returns to its initial count value on the occurrence of each line. When the cyclic line recurrence counter returns to its original count value on the occurrence of the predetermined first line, a pixel counter incremented by the clock signal and a line counter incremented by successive occurrences of video lines are triggered. When the line counter reaches a count value corresponding to the rank of the predetermined second line, the difference between the count value of the pixel counter and the count value of the cyclic line recurrence counter is measured and compared to the predetermined threshold, which can be of the order of around 20 pixels, for example.

The line delay of 128 lines is therefore obtained by means of a double counter. This embodiment includes a pixel counter and a line counter. This duplication takes account of the risk of phase jumps or period variations of sufficient magnitude to introduce the risk of skewing the counting of lines based only on the number of pixels (i.e., number of clock pulses). Over 128 lines, a relatively small variation of the period is sufficient for the 128^{th} line to be indistinguishable from the 127^{th} line or the 129^{th} line.

If the difference between the count value in the pixel counter and the count value in the cyclic line recurrence counter forming the oscillator is greater than the predetermined threshold, it is determined that there has been a phase jump between the two lines. On the other hand, if the difference is small, for example less than around 20 pixels, it is determined that there has been no phase jump and that there is no need to switch to the video recorder mode. Further, in this case, any serious phase error that might be observed in the vicinity of vertical synchronization is ignored, because such errors would probably be measurement errors caused by encryption for copy protection.

When a video recorder has been identified, the video synchronization circuit is put into a “video recorder” operating mode in which the time constant of the phase-locked loop has a value lower than that in the normal operating mode. The video synchronization circuit remains in the video recorder mode for as long as new crossings of the predetermined threshold are not detected during a predetermined time period, for example a time period of about one second, corresponding to several tens of frames. In this case the video recorder mode is maintained for a predetermined minimum time period, which is reinitialized on each new crossing of the predetermined threshold. The predetermined minimum time period prevents reversion to the normal mode if a video recorder briefly cancels its phase jump.

In yet another embodiment of the present invention, the phase-locked loop is a digital loop including an oscillator formed of a cyclic line recurrence counter incremented by the clock signal. In this embodiment, the means for detecting the nature of the video signal includes a pixel counter incremented by the clock signal and a line counter incremented by successive occurrences of video lines. The pixel counter and the line counter are triggered when the cyclic line recurrence counter returns to its original count value on the occurrence of the predetermined first line. The means for detecting the nature of the video signal further includes measuring means adapted, when the line counter reaches a count value corresponding to the predetermined second line, to measure the difference between the value of the pixel counter and the value of the cyclic counter. A comparator means are then adapted to compare the difference between the value of the pixel counter and the value of the cyclic counter with the predetermined threshold.

In yet another embodiment of the present invention, if a video recorder is detected, the video synchronization circuit operates in a video recorder operating mode in which the time constant of the phase-locked loop has a lower value than in a normal operating mode. Further, the video synchronization circuit is maintained in the video recorder mode until the detector means detects further crossing of the predetermined threshold during a predetermined time period. Yet another embodiment of the present invention provides an integrated circuit for detecting the nature of a video signal using a video synchronization circuit.

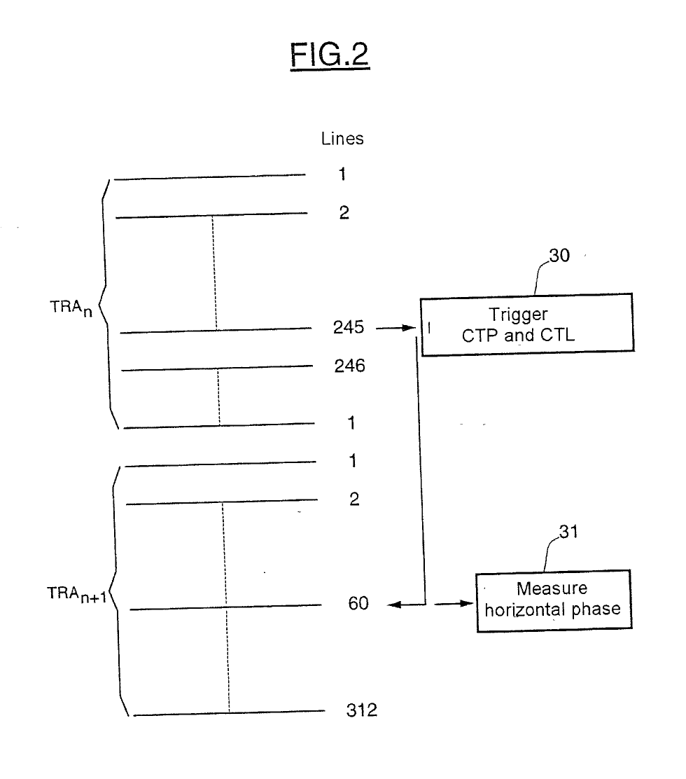

FIG. 1 is a diagram of a video synchronization circuit, according to one embodiment of the present invention. A video synchronization circuit CVD receiving an analog signal CVBS, and which is implemented as an integrated circuit (on a silicon chip, for example), includes horizontal synchronization means MSH, the structure and operation of which are known to a person of ordinary skill in the art. Specifically, the horizontal synchronization means include a digital phase-locked loop PLL delivering a reference signal SRF from a controlled loop oscillator OSC. Conventionally, the reference signal SRF is the output signal of the horizontal synchronization means MSH and is synchronized to the video signal. I.e., after synchronization, and under steady state conditions, transitions TRi in the signal SRF (see FIG. 2) correspond to horizontal synchronization pulses in the video signal.

The signal SRF is also fed back to the phase comparator CP of the loop PLL. The oscillator OSC is controlled via the loop filter FB (which is a PI (proportional-integral) filter, for example) by an error signal representative of the phase difference between the digitized video signal CVBS and the signal SRF. The sampling frequency used by the horizontal synchronization means MSH is about 27 MHz, for example, corresponding to a sampling clock whose rising edges are spaced by about 37 nanoseconds.

In an example, the oscillator OSC is a cyclic line recurrence counter, which is incremented by the sampling clock signal and whose final nominal count value is equal to 1727, for example, which corresponds to a video line length of 64 microseconds. Of course, the final count value of this cyclic line recurrence counter can be varied around the nominal value to enable synchronization to the video signal CVBS.

In addition to the horizontal synchronization means MSH, the video circuit CVD includes a system DCD for controlling the operation of the video synchronization circuit MSH. The control system DCD includes detector means MDT adapted to detect the nature of the video source emitting the signal CVBS. The control system DCD further includes control means MCD adapted, by means of a control signal SCD, to adjust the time constant of the phase-locked loop PLL of the video synchronization circuit MSH as a function of the nature of the video source.

FIG. 2 is a chart depicting the operation of the phase difference calculation process, according to another embodiment of the present invention. The detector means MDT determine the horizontal phase difference between a predetermined first line and a predetermined second line bracketing a change of frame. Specifically, the predetermined first line is line 245 of the frame TRAₙ and (for 50 Hz scanning) the predetermined second line is line 60 of the next frame TRAₙ₊₁, for example. To determine the phase difference, a pixel counter CTP is incremented by the sampling clock signal and a line counter CTL is incremented by successive occurrences of video lines (successive occurrences of horizontal synchronization pulses, for example).

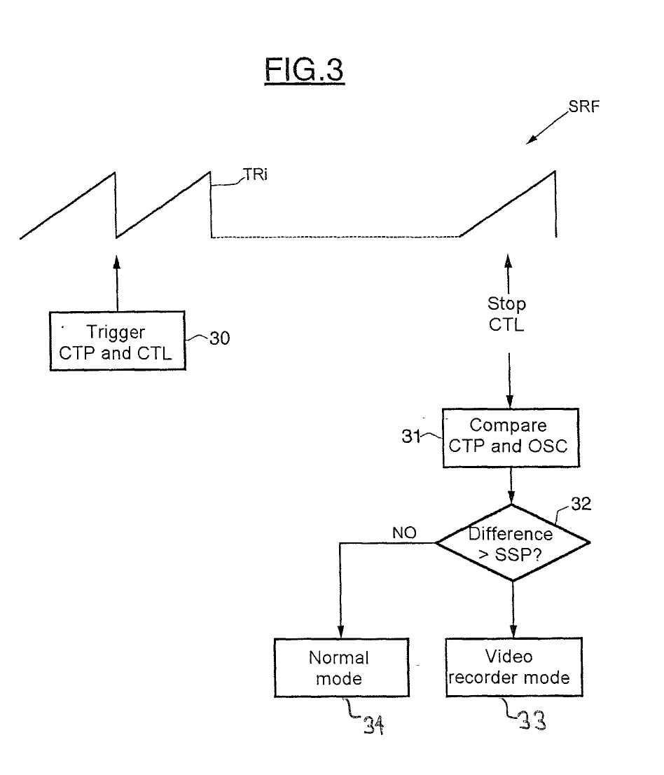

FIG. 3 is a flowchart depicting the operation and control flow of the video mode determination process, according to yet another embodiment of the present invention. With reference to step 30 of FIG. 2 and FIG. 3, the pixel counter CTP and the line counter CTL are triggered by triggering means MDL when the cyclic line recurrence counter forming the oscillator OSC of the loop PLL reverts to its original counter value on the occurrence of the predetermined first line (line 245 in this example). When the line counter CTL reaches a value corresponding to the predetermined second line (line 60 in this example), the measurement means MMS measure the difference between the count value of the pixel counter CTP and the count value of the cyclic line recurrence counter forming the oscillator OSC (with reference to step 31 of FIG. 2 and FIG. 3). In step 32, comparator means CMP then compare the difference to a predetermined threshold SSP of around 20 pixels, for example. If the difference is greater than the threshold SSP, the mode is video recorder mode 33, and the control means MCD adjust the time constant of the loop PLL to give it a low value (from 10 to 30 lines, for example). The low value adjusted by control means MCD is less than the time constant in a normal operation mode (typically about one hundred to several hundred lines). If the threshold is met in step 32, the normal mode 34 is entered.

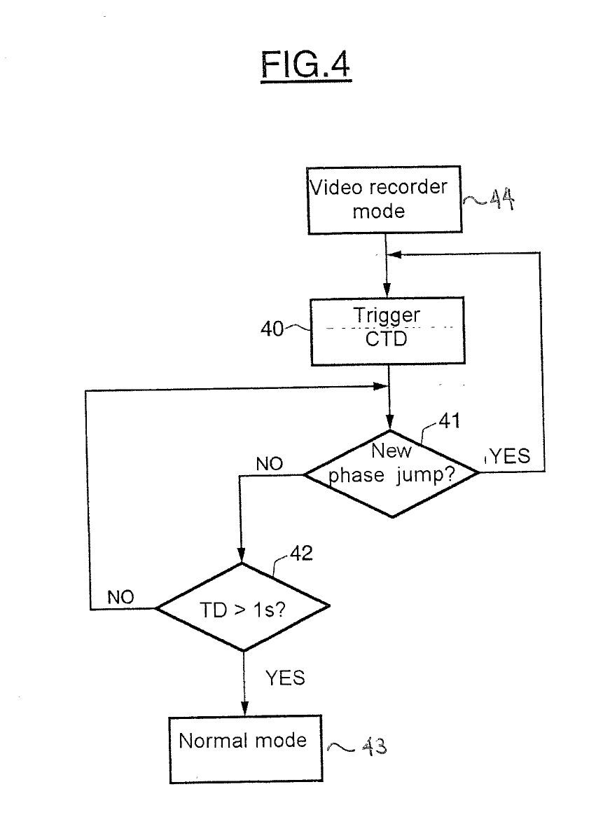

FIG. 4 is a flowchart depicting the operation and control flow of the video mode determination process, according to yet another embodiment of the present invention. If the control means have detected a video recorder mode step 44, control means MCTL trigger a counter CTD (see step 40 of FIG. 4). With reference to steps 41 and 42 of FIG. 4, the video synchronization circuit MSH is maintained in the video recorder mode until the detector means detect further crossings of the predetermined threshold during a predetermined time period TD (about one second (is), for example). If the threshold is met in step 42, the system goes to normal mode in step 43. In the absence of new phase jumps, the control means MCTL adjust the time constant of the loop PLL to a greater value. In hardware terms, the means MDT and MCD can be implemented in the form of hardwired logic in an integrated circuit.

While there has been illustrated and described what are presently considered to be the preferred embodiments of the present invention, it will be understood by those skilled in the art that various other modifications may be made, and equivalents may be substituted, without departing from the true scope of the present invention. Additionally, many modifications may be made to adapt a particular situation to the teachings of the present invention without departing from the central inventive concept described herein. Furthermore, an embodiment of the present invention may not include all of the features described above. Therefore, it is intended that the present invention not be limited to the particular embodiments disclosed, but that the invention include all embodiments falling within the scope of the appended claims.

What is claimed is:

1. A method for detecting the nature of a video signal using a video synchronization circuit including a phase locked loop having a time constant, the method comprising:
calculating a horizontal phase difference between a predetermined first line of the video signal and a predetermined second line of the video signal, wherein the predetermined first line and the predetermined second line bracket a change of frame and wherein if the horizontal phase difference is greater than a threshold, the video signal is deemed to be a video recorder signal; and
adjusting the time constant of the phase locked loop of the video synchronization circuit according to the whether the of the video signal is deemed to be a video recorder signal, as determined in the calculating step.

2. The method of claim 1, wherein the number of lines between the predetermined first line and the predetermined second line is equal to 128 and wherein the predetermined first line is line number 245.

3. The method of claim 1,
wherein the phase-locked loop is a digital loop including an oscillator having a cyclic line recurrence counter incremented by a clock signal,
wherein if the cyclic line recurrence counter returns to an initial count value upon the occurrence of the predetermined first line, a pixel counter incremented by the clock signal is triggered and a line counter incremented by successive occurrences of lines is triggered, and
wherein if the line counter reaches a count value corresponding to a rank of the predetermined second line, a difference between the count value of the pixel counter and the count value of the cyclic line recurrence counter is compared to the threshold.

4. The method of claim 1, wherein the threshold is about twenty.

5. The method of claim 1, wherein if the video signal is deemed to be a video recorder signal in the calculating step, the video synchronization circuit operates in a video recorder mode, wherein the time constant of the phase locked loop is reduced, until the video signal is deemed not to be a video recorder signal in a subsequent calculating step during a predetermined time period.

6. The method of claim 5, wherein the predetermined time period is a few tens of frames.

7. A system for detecting the nature of a video signal using a video synchronization circuit including a phase locked loop having a time constant, comprising:
means for calculating a horizontal phase difference between a predetermined first line of the video signal and a predetermined second line of the video signal, wherein the predetermined first line and the predetermined second line bracket a change of frame and wherein if the horizontal phase difference is greater than a threshold, the video signal is deemed to be a video recorder signal; and
means for adjusting the time constant of the phase locked loop of the video synchronization circuit according to whether the the video signal is deemed to be a video recorder signal, as determined by the means for calculating.

8. The system of claim 7, wherein the number of lines between the predetermined first line and the predetermined second line is equal to 128 and wherein the predetermined first line is line number 245.

9. The system of claim 7,
wherein the phase-locked loop is a digital loop including an oscillator having a cyclic line recurrence counter incremented by a clock signal,
wherein if the cyclic line recurrence counter returns to an initial count value upon the occurrence of the predetermined first line, a pixel counter incremented by the clock signal is triggered and a line counter incremented by successive occurrences of lines is triggered, and
wherein if the line counter reaches a count value corresponding to a rank of the predetermined second line, a difference between the count value of the pixel counter and the count value of the cyclic line recurrence counter is compared to the threshold.

10. The system of claim 7, wherein the threshold is about twenty.

11. The system of claim 7, wherein if the video signal is deemed to be a video recorder signal by the means for calculating, the video synchronization circuit operates in a video recorder mode, wherein the time constant of the phase locked loop is reduced, until the video signal is subsequently deemed not to be a video recorder signal by the means for calculating during a predetermined time period.

12. The system of claim 11, wherein the predetermined time period is a few tens of frames.

13. An integrated circuit for detecting the nature of a video signal using a video synchronization circuit including a phase locked loop having a time constant, comprising:
a first module for calculating a horizontal phase difference between a predetermined first line of the video signal and a predetermined second line of the video signal, wherein the predetermined first line and the predetermined second line bracket a change of frame and wherein if the horizontal phase difference is greater than a threshold, the video signal is deemed to be a video recorder signal; and
a second module for adjusting the time constant of the phase locked loop of the video synchronization circuit according to the nature of the video signal, as determined by the first module.

14. The integrated circuit of claim 13, wherein the number of lines between the predetermined first line and the predetermined second line is equal to 128 and wherein the predetermined first line is line number 245.

15. The integrated circuit of claim 13,
wherein the phase-locked loop is a digital loop including an oscillator having a cyclic line recurrence counter incremented by a clock signal,
wherein if the cyclic line recurrence counter returns to an initial count value upon the occurrence of the predetermined first line, a pixel counter incremented by the clock signal is triggered and a line counter incremented by successive occurrences of lines is triggered, and
wherein if the line counter reaches a count value corresponding to a rank of the predetermined second line, a difference between the count value of the pixel counter and the count value of the cyclic line recurrence counter is compared to the threshold.

16. The integrated circuit of claim 13, wherein the threshold is about twenty.

17. The integrated circuit of claim 13, wherein if the video signal is deemed to be a video recorder signal by the first module, the video synchronization circuit operates in a video recorder mode, wherein the time constant of the phase locked loop is reduced, until the video signal is subsequently deemed not to be a video recorder signal by the first module during a predetermined time period.

18. The integrated circuit of claim 17, wherein the predetermined time period is a few tens of frames.
